(19) United States
(12) Patent Application Publication
(10) Pub. No.: US 2007/0057893 A1
(43) Pub. Date: Mar. 15, 2007

(54) RFID transponder arrays for controlling and powering pixels

(76) Inventor: Ray M. Alden, Raleigh, NC (US)

Correspondence Address: Ray M. Alden, 808 Lake Brandon Trail, Raleigh, NC, 27610, US

(21) Appl. No.: 11/376,799

(22) Filed: Mar. 16, 2006

Related U.S. Application Data
(63) Continuation-in-part of application No. 11/224,163, filed on Sep. 12, 2005.
(60) Provisional application No. 60/759,084, filed on Dec. 12, 2005.

(51) Int. Cl. G09G 3/36

(52) U.S. Cl. 345/97

(57) ABSTRACT

The invention described herein represents a significant advancement in electric display addressing and powering. A first display element comprising a first wireless transponder element is integrated with a first pixel element so as to controllably turn the pixel element on and off according to instructions received wirelessly from an RFID reader and in accordance with an image in a memory. The electronic display comprising a plurality of similar display elements in array each individually controlled wirelessly by an RFID reader dialog in accordance with an image in memory and a processor of the image in communication with the RFID reader.

### PRIOR and RELATED APPLICATIONS

This application is a Continuation In Part of U.S. patent application Ser. No. 11/224,163 filed Sep. 12, 2005 and of U.S. Provisional Patent Application No. 60/759,084 filed Dec. 12, 2005 and of a US patent application filed Mar. 7, 2006, the number of which is not known at the filing date of the present application.

### BACKGROUND FIELD OF INVENTION

The field of invention relates to electric displays and more specific to a display pixel addressing system that is wireless at the pixel level. The present invention combining an electric display pixel element with a wireless RFID pixel level control element.

### BACKGROUND-DESCRIPTION OF PRIOR INVENTION

The prior art includes many electric displays that comprise a plurality of pixels in array wherein each pixel is controlled to be either a first observable state or a second observable state and in which the plurality of pixels combine to communicate meaningful visible information such as alphanumeric characters or graphics. The prior art also includes RFID transponders which comprise a chip and which can operate with no chip and in either case wherein the transponders can be addressed wirelessly to receive information from a reader and based upon the communication from the reader, produce desirable electric effects in a circuit which may comprise a coil or a capacitor. The present invention combines display pixels known in the prior art with pixel level element control based upon wireless RFID technology known in the prior art to achieve a wirelessly display that is wirelessly addressable at the pixel level wherein this combination offers significant and unexpected advantage over the prior art for example when used in combination with prior patent applications of the present applicant.

### BRIEF SUMMARY

The invention described herein represents a significant advancement in manufacturing cheap, reliable displays that can be addressed and powered wirelessly and can be manufactured in a thin profile. A display of the present invention comprising a pixel element that is one among a plurality of similar pixel elements in array operating in combination to form a discernable image such as an alphanumeric character or a graphic. Wherein the individual pixel elements are controlled to be in either a first darker state or a second lighter state and wherein the control element for switching each pixel element is in communication with an individual pixel and can be wirelessly controlled. Moreover the control element, according to a wireless signal, controls power to the pixel element to switch to it a lighter state or darker state according to data in a memory that is communicated to the display wirelessly.

Thus the present invention offers a significant advancement in the ability to communicate an unlimited range of visible image information in a low cost wireless interface with out complex integration problems and without need for batteries.

### OBJECTS AND ADVANTAGES

Accordingly, several objects and advantages of the present invention are apparent. It is an object of the present invention to provide a means to reliably and inexpensively communicate a very wide range of visible image information using a wireless technique. It is an object of the present invention to provide a means to reliably and inexpensively communicate a very wide range of user determined information using an RFID technique. It is an object of the present invention to create a data input and communication means for a wide range or uses. It is an advantage of the present invention to eliminate the need for batteries in wireless devices. It is an advantage of some embodiments that they are completely solid state with no moving parts. It is an advantage of the present invention that individual circuits are used and complex integration of circuits together is not required. It is an advantage that something as simple as a sheet of paper with pixels and controllers printed thereon can be used as an electronic display to communicate a wide range of alphanumeric and graphic information.

Further objects and advantages will become apparent from the enclosed figures and specifications.

### DRAWING FIGURES

FIG. 1 illustrates an RFID controlled transponder pixel in a first “off” dark state.

FIG. 2 illustrates the RFID controlled transponder pixel of FIG. 1 except in a second “on” bright state.

FIG. 3 illustrates two alternate embodiments of RFID controlled transponder pixels including transponder coil field based pixel control configuration and transponder control of a remote power source configuration.

### NUMERALS in FIGURES

21 transponder chip
22 printed circuit board
23 coil
24 inert core
capacitor
26 “off” switch
27 reflective electrode
28 transparent electrode
29 first state liquid crystal
polarizing film
31 LC Pixel and control
40 reader
41 first reader output
42 processor
43 memory
45 reflective liquid crystal array with first image
51 user writing array
52 user device array
53 user wireless input
55 display integration
71 ambient light
21a “on” transponder chip
22a “on” printed circuit board
25a “on” capacitor
26a “on” switch
27a “on” reflective electrode
28a “on” transparent electrode
29a second state liquid crystal
31a “on” LC Pixel and control
40a reader with “on” signal
41a second reader output
42a image “on” processor
43a new image memory
45a reflective liquid crystal array with second image
51a user writing array with input
52a user device array with input
53a second user wireless input
71a second ambient light
72 reflected light
21b alternate transponder chip
22b alternate pcb
31b alternate liquid crystal pixel and control
81 ferrite core
82 alignment
83 alternate power source

### DETAILED DESCRIPTION OF THE INVENTION

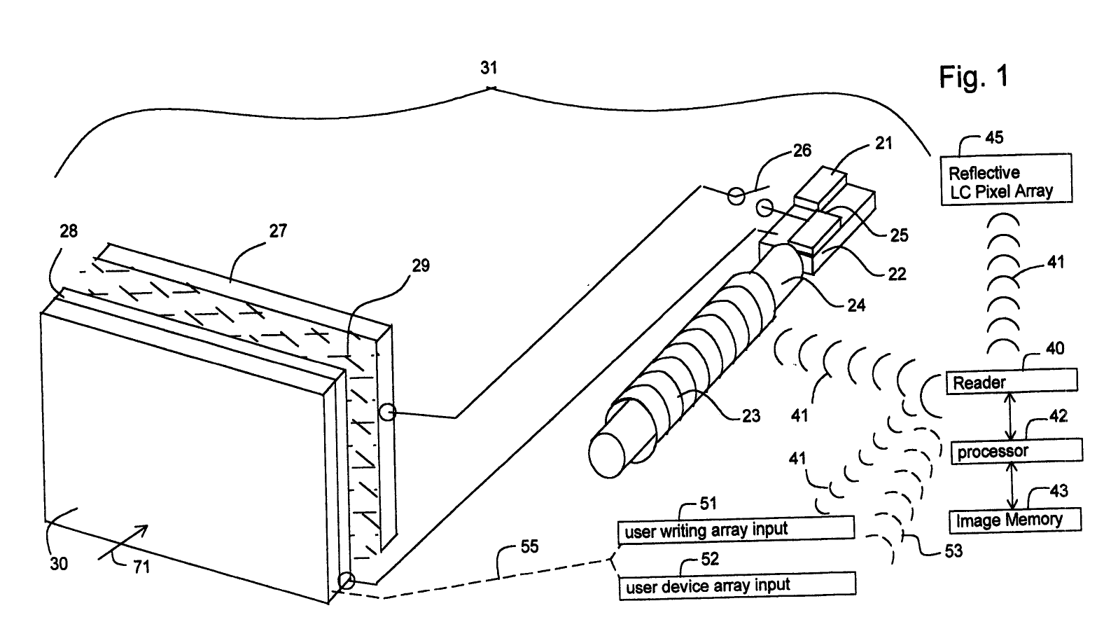

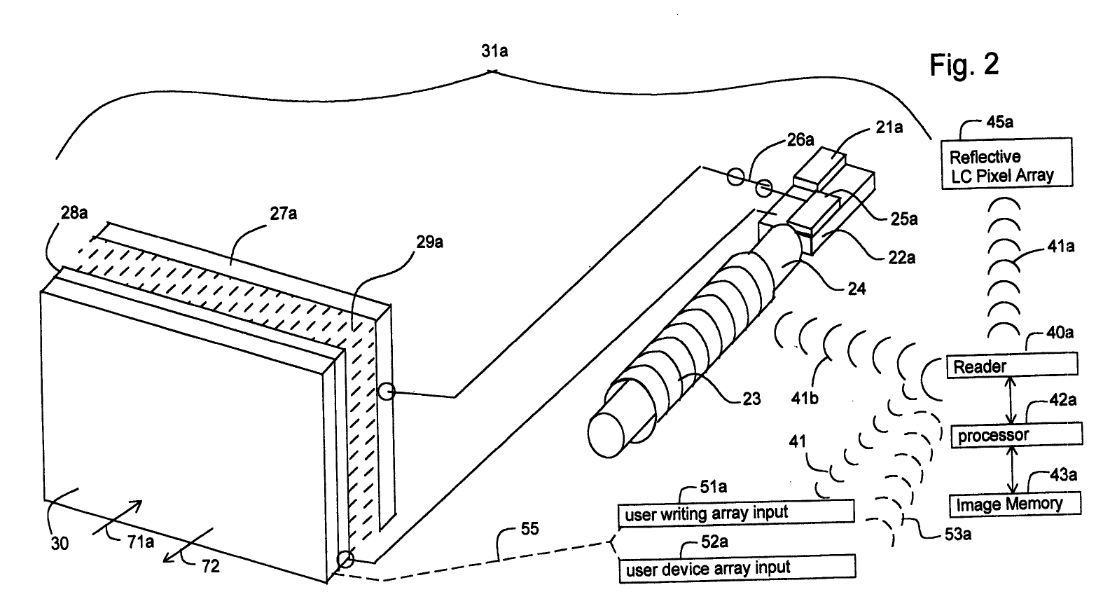

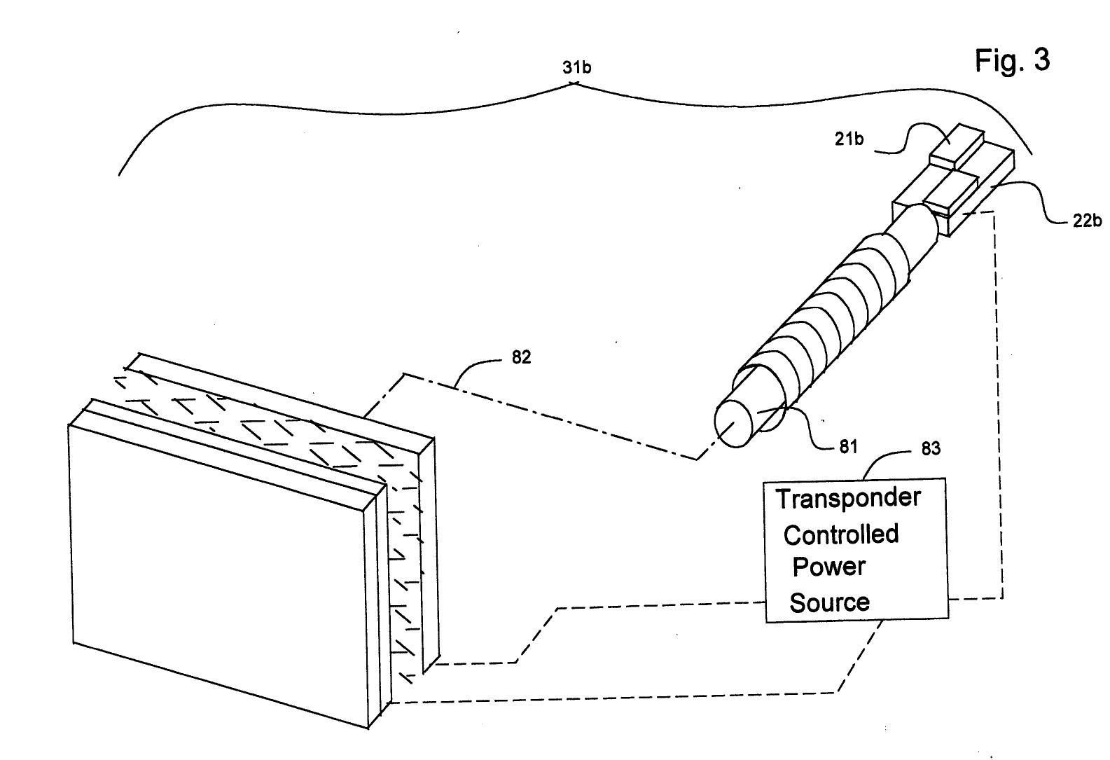

FIG. 1 illustrates an RFID controlled transponder pixel in a first “off” dark state. A transponder chip 21 is manufactured, configured, and positioned according to the prior art on a printed circuit board 22 such that it derives power from a coil 23 having an inert core 24. As is common in transponders of the prior art, a capacitor 25 is provided that stores power collected through induction by the coil 23. The emission of energy by the capacitor 25 being controlled, similarly to the prior art, by the transponder chip 21 via an “off” switch 26. In contrast to the prior art, the “off” switch 26 is in electrical communication with an “off” reflective electrode 27. The “off” reflective electrode 27 is common in the prior art of reflective liquid crystal displays in that it has suitable electrical properties to communicate an electric field (as in FIG. 2), it also has polarized optical properties on its front surface to reflect properly directed ambient light (as in FIG. 2) and an absorptive layer on its rear surface to absorb improperly directed light as in this FIG. 1. Also in communication with the printed circuit board 22 is a transparent electrode 28 being transmissive to visible light and able to communicate an electric field (as in FIG. 2) such transparent electrodes being common in the prior art for use with liquid crystal cells. When the “off” switch 26 is in the “off” state, a first state liquid crystal 29 is configured in a first light directing state so as to direct light to be absorbed by the rear surface of the “off” reflective electrode such that the cell can be observed to be in a visibly darker state which absorbs an ambient light 71 which is polarized, directed, and absorbed by the pixel in FIG. 1 (and is polarized, directed, and reflected by the pixel in FIG. 2). As is common in the art of liquid crystals, a polarizing film 30 is provided to ensure that light is properly directed by the liquid crystal when passing there through. The elements described heretofore and further described herein comprising an individual LC Pixel and control 31 according to the present invention. The LC Pixel cell being a display element that can transition between a first visible state and a second visible state, the two states being visibly distinguishable from one another by an observer. The control means being an RFID transponder that controls when energy is to be applied to the LC Crystal to cause it to transition between a first visible state and a second visible state or to maintain a first visible state or to maintain a second visible state. The RFID transponder control means is in wireless communication with a reader 40 which is common to the prior art of RFID communication systems with respect to fabrication and operation. The LC Pixel and control 31 comprising the means to receive a signal from an RFID reader, store energy from an RFID reader, and apply the energy from the RFID reader to a liquid crystal at the direction of the RFID reader according to FIG. 1 and FIG. 2 or alternately to apply energy from a secondary power source according to FIG. 3. According to the prior art of RFID systems, the reader 40 is in communication with a processor 42 and a memory 43 which together operate to process incoming signals and selectively send outgoing signals such as those representing images from the memory through the processor through the reader to a reflective liquid crystal array with first image 45. The reflective liquid crystal array with first image 45 comprising a plurality of pixels with associated controls identical to the LC Pixel and control 31 and wherein a first reader output 41 comprises a wireless signal which is communicated to each of the transponders in the reflective liquid crystal array with first image 45 such that each respective pixel element is caused to either take a first “on” state or a second “off” such that the plurality of pixels form a character or image conforming to that which is stored in memory, processed by the processor, and sent wirelessly by the reader. The signal from the reader can comprise a series of individual communications to respective individual transponders in series with an analog instruction being received by each respective transponder which is caused to accordingly either open or close its respective switch to control power to its associated liquid crystal contacts such that each individual LC pixel will be controlled to be either visibly in a first darker “off” state or a second brighter “on” state. The first reader output 41 also comprises an RFID signal which is used to power the plurality of transponders, and the plurality of LC pixels, and to communicate with other RFID elements as is common in the prior art. As depicted in FIG. 1, the first reader output 41 comprises signals to the plurality of respective transponders to each turn “on” or “off” a respective individual pixel in accordance with the image that the reader is communicating from the memory. In FIG. 1, the 31 pixel is instructed by the reader to be in the “off” state as part of a larger image comprising the plurality of arrayed pixels in accordance with that in memory and sent by the reader. The image formed by the display can be an alphanumeric character such as is common on calculator displays for displaying numbers entered by the user and calculated by the calculator's processor. Additionally, the image formed by the display can be a graphic image such as is common on cell phones. The art described herein being suitable for a wide range of displays and applications.

Both a user writing array 51 which accepts a users hand writing and which is RFID readable and convertible to data and a user device array 52 according to inventions described by the present inventor (the three Patent Applications referenced at the top of the present Application and of which the present application is a Continuation in Part are incorporated herein by reference) can be integrated with the RFID controlled display described herein such that the hand writable array or the user input device array can be operated by a user to be caused to emit via RFID a user wireless input 53 as a wireless communication with the reader. Based upon the user's input, the reader can wirelessly communicate back to the display either an image of what the user input or an image resulting from a calculation based upon what the user input. In a display integration 55 step, the display can be physically integrated into the user input device such that as a user inputs a character into the device in the referenced prior Patent Applications, that character can be sensed by the reader, interpreted and sent back to the display, such that, in concurrent time or nearly concurrently, the user can see on the display the characters that the reader has interpreted as his input into the device. Thus the display integrated with the user input device gives the user the opportunity to ensure that his input is being correctly received and interpreted by the reader in cooperation with the processor and the memory. In this scenario, the user device with integrated display will comprise a very cheap, battery-less, wireless device that accepts user input and displays the user input but which has no onboard means of associating the user's input with the displayed input since that capability is all on the reader side of the system and communicated wirelessly to and from the reader respectively. Additionally, in a calculator application for example, that is illustrative of one application among many, the user inputs alphanumeric characters or numbers and operational commands, the reader wirelessly senses the user's input which is processed by the processor to calculate an answer which is then wirelessly sent to the display by the reader.

Together, the elements such as transponder chip 21, printed circuit board 22, coil 23, and capacitor 25 comprise an RFID transponder of the prior art, which can be constructed similarly to a Texas Systems transponder described on page 15 of RFID Handbook by Finkenzeller Published in 2003 by Wiley, and these elements comprise the transponder and control portion of the LC Pixel and control 31.

Together the “off” reflective electrode 27. transparent electrode 28, first state liquid crystal 29, and polarizing film 30 comprise a display pixel that can transition between a first visible state such as the darker state in FIG. 1 and a second visible state such as the brighter state in FIG. 2 which can be fabricated and operated according to the prior art such as that described on page 14 of Reflective Liquid Crystal Displays by Wu and Yang published in 2001 by Wiley. Such individual pixels often being combined with arrays of a plurality of pixels to form a display wherein information displayed thereon can be varied. The present invention providing a variable pixel that can be wirelessly controlled by an associated pixel level transponder/controller.

FIG. 2 illustrates the RFID controlled transponder pixel of FIG. 1 except in a second “on” bright state. A “on” transponder chip 21a has received instructions to switch to a brighter state according to a second reader output 41a sent by a reader with “on” signal 40a. The “on” transponder chip 21a applies current in conjunction with an “on” printed circuit board 22a, from an “on” capacitor 25a, via an “on” switch 26a. The current from the “on” capacitor is applied to a second state liquid crystal 29a via an “on” reflective electrode 27a and an “on” transparent electrode 28a the current realigning a reflective liquid crystal array with second image 45a such that it directs a second ambient light 71a to be a reflected light 72 according to the art described in FIG. 1. Thus an “on” LC Pixel and control 31a is transitioned from a darker first state of FIG. 1 and a brighter second state of FIG. 2. The brighter state of the “on” LC Pixel and control 31a conforming with an image which was processed by an “on” processor 42a and stored in new image memory 43a. The image displayed by a plurality of pixels according to the image in the new image memory may be an alphanumeric character comprising a second user wireless input 53a through a user writing array with input 51a or a user device array with input 52a as integrated and cooperating with the display as described in FIG. 1.

FIG. 3 illustrates two alternate embodiments of RFID controlled transponder pixels including transponder coil field based pixel control configuration and transponder control of a remote power source configuration.

In a first alternate embodiment, an alternate transponder chip 21b an alternate pcb 22b differ in combination from those described in FIG. 1 in that the switch that is controlled is in communication with a the coil such that when the switch is in the “on” state, the current from the capacitor passes through the coil which in combination with a ferrite core 81 and a close alignment 82, causes a magnetic filed to be applied to the liquid crystal such that the liquid crystal can be transitioned between a first alignment state when no field is applied and a second alignment state when a field is applied. This embodiment comprising an alternate liquid crystal pixel and control 31b.

In a second alternate embodiment, an alternate power source 83 is utilized to power the liquid crystal according to FIG. 1 and FIG. 2 except that the to be directed to the liquid crystal is not derived from the reader but is instead derived from a separate power source such as a photovoltaic cell or a battery. In this embodiment, the switch controlled by the chip allows power to pass from the power source to the liquid crystal cell.

Where the alternate power source is utilized, as an alternate approach, it is possible to essentially have a chip controlling the power at the pixel level as is described herein while either or both of the antennae (or coil) and the power source are linked to a plurality of chips. In such a configuration, the chip still controls the state of the pixel cell between darker or lighter but it receives power from a supply that is in electrical communication with a plurality of chips/pixels and/or it is in signal communication with an antenna that is in communication with a plurality of chips/pixels.

Operation of the Invention

Operation of the invention has been discussed under the above heading and is not repeated here to avoid redundancy.

### CONCLUSION, RAMIFICATIONS, AND SCOPE

Thus the reader will see that the RFID Transponder Arrays for Controlling and Powering Pixels comprise arrays of a plurality of individually switchable optical elements each of which can be switched between a respective first visible state and second a second visible state and whereby the control mechanism to switch between these two state resides at the pixel level and receives instructions regarding what state to produce wirelessly using and RFID technique and as part of a larger visible display controlled by remote processes. The resulting display being suitable for a very wide range of low cost applications.

While the above description describes many specifications, these should not be construed as limitations on the scope of the invention, but rather as an exemplification of a preferred embodiment thereof. Many other variations are possible for example:

The art described herein uses arrays of individual transponder/sensor elements that are configured to act dually as sensors and pixel controllers and while RFID is specified as the technique for wirelessly controlling the status of individual elements, it will be understood by those skills in the art that other sensor/controller elements may be substituted to perform similarly, microwave, and SAW being two examples of elements that can be arrayed as described herein to wirelessly sense an instruction and to accordingly control the visible state of a pixel element.

The above description specifies a plurality of pixel elements comprising an array of controllable liquid crystal segments that can be transitioned between a first visible state (dark state) that can be observed by a user and a second visible state (bright state) that can be observed by a user and wherein a user can discern between these two states such as in reflective liquid crystal displays well know for many years in the prior art. It will be understood by one skilled in the art of displays that other controllable pixel elements that can transition between two visible states are known in the prior art that can be readable substituted herein. For example if an OLED pixel element or LED pixel element can be substituted for the liquid crystal element in FIGS. 1, 2, and 3 to be remotely controlled as described herein to be a first emitting state or a second non-emitting state and to be remotely powered as described herein. An array of such individual elements may comprise a color display.

Also, a photo sensitive diode element can be substituted as described in the preceding paragraph together with a reverse biasing circuit that delivers an electric current to the chip in a light sensing state and no current to the chip in a light not sensing state and wherein the chip reports to the reader the state of the signal from the photo sensitive element. Thus an individual light sensing pixel can be produced and together with a similar plurality be arrayed to form a camera

The above description discloses a transponder comprising electronic elements in a configuration and in communication with a display, it will be understood by one skilled in the art that many other configurations and elements are possible.

The above description comprises a transponder including a chip element. It is understood that so called chipless transponders know in the prior art can be substituted with the resulting transponder functioning to control power to a respective pixel similarly to as described herein.

The above description emphasizes the use of passive RFID transponders but active transponders can be substituted.

The above description does not describe a dialog from the pixel level transponder to the reader but it is understood that such a two way dialog may be desirable and is achievable according to RFID practices well known in the prior art.

An array of integrated circuit connections that can be read through a single RFID sender has been described by the present applicant in applications which are incorporated herein by reference such as U.S. patent application Ser. No. 11/224 and U.S. Provisional Patent Application No. 60/759,084 the integrated circuit connections and associated RFID sender being replaceable by the transponder array described herein.

According to the prior disclosures of the present applicant, the user may interact with the display transponder by touching it or bringing a stylus in close proximity to it so as to change its readable state as a user input means.

Each of the transponders is described as comprising a coil power system but it is understood that a corporate coil power system is possible or a corporate battery power system is also possible.

Each of the transponders is described as comprising a circuit system but it is understood that a corporate circuit is possible.

Each of the transponders is described as comprising an RFID antenna but it is understood that a corporate RFID antenna is possible.

Each of the transponders is described as comprising a chip but it is understood that a corporate chip is possible such as in the art of the present application referenced herein. Alternately the chip can be eliminated as is the case with printable RFID transponders known in the prior art.

The communication from the reader to the transponder may take a form that varies with regard to readability, intensity, frequency, wavelength, modulation pattern, or any other discernable or readable communication code.

What is claimed:

1. An electronic display comprising;
a first transponder,
a first display pixel,
a plurality of transponders,
a plurality of pixels,
a wireless communication signal,
and wherein in response to said wireless communication signal, said first transponder causes said first display pixel to transition between a first visible state and a second visible state, and wherein the plurality of similar transponders individually control respective individual pixels in said plurality of pixels to individually transition between either of at least two visible states in response to the wireless communication signal, such that an image comprising a controlled pattern of pixels including some in the first visible state and some in the second visible state is displayed on the electronic display.
